(19) United States
(12) Patent Application Publication
(10) Pub. No.: US 2003/0083774 A1
(43) Pub. Date: May 1, 2003

(54) Integrated utility backup system

(76) Inventors: Philip B. Simon, Ann Arbor, MI (US); Mark T. DeLong, Pinckney, MI (US); Peter M. Simon, Jackson, MI (US)

Correspondence Address: James M. Deimen, Suite 300, 320 N. Main Street, Ann Arbor, MI, 48104-1192, US

(21) Appl. No.: 10/156,743

(22) Filed: May 28, 2002

Related U.S. Application Data
(63) Continuation of application No. 09/233,219, filed on Jan. 19, 1999, now abandoned.
(60) Provisional application No. 60/071,784, filed on Jan. 19, 1998.

(51) Int. Cl. G05D 5/00

(52) U.S. Cl. 700/209

(57) ABSTRACT

An industrial or laboratory system that provides sufficient backup of all utilities for sufficient time to allow for orderly shut down of the industrial or laboratory supplied system or the re-establishment of normal utilities. The new backup system stores and uses the facility utilities and supplies the utilities as required to avoid abrupt and potentially damaging shutdown. The new backup system also monitors and regulates the supplied system as necessary and provides communication of backup events through automated telecommunication equipment. Changes in supplied system utilities are automatically logged into an event log to allow an operator to determine which utility has experienced a detectable service interruption, what type of interruption the utility has experienced and the action taken by the computer logic control.

### BACKGROUND OF THE INVENTION

1. Field of the Invention

This invention relates in general to supplying alternate systems operation utilities to computer operated, automated industrial and laboratory mechanical systems. In particular, this invention is directed to the supply of electric, gas, water, air and/or other critical operational supplies to an industrial or laboratory mechanical system in a specified amount, for a specified time period, in the event of a utility failure which would otherwise abruptly shut the mechanical system down.

2. Prior Art

U.S. Pat. No. 4,457,326 discloses a temporary water loop between a water main and one or more locations normally connected to the main.

### SUMMARY OF THE INVENTION

The principal object of the present invention is to avoid abrupt and potentially damaging shutdown of important industrial or laboratory systems by providing sufficient backup of all utilities for sufficient time to allow for orderly shutdown of the laboratory or industrial system or the re-establishment of normal utilities.

The Integrated Utility Backup System (IUBS), using standard facility utilities, supplies, monitors, regulates, provides uninterruptible process utilities, and provides communication of the event through automated telecommunication equipment. The IUBS maintains constant utility service, monitors for changes in standard facility utilities supplied to a process, provides a means of communication of these changes to a computer logic controller with remote telecommunications to designated operator(s), and allows for the systematic, automated shutdown of computer software and computer controlled equipment, in the event standard facility utilities are interrupted for a predetermined period of time. Changes in process utilities are electronically logged in an event log, to allow an operator to determine what utility has experienced a detectable service interruption, what type of interruption the utility has experienced, and the action taken by the computer logic control. The computer logic controller has software adjustable set points to allow the operator to define the limits under which the IUBS is to take action.

### BRIEF DESCRIPTION OF THE DRAWINGS

FIG. 1 is a generalized flow diagram of the new backup system

FIG. 2 is a deionized water backup flow diagram

FIG. 3 is a compressed air backup flow diagram

FIG. 4 is a skid mount installation plan view of a deionized water and compressed air backup system

### DESCRIPTION OF THE PREFERRED EMBODIMENTS

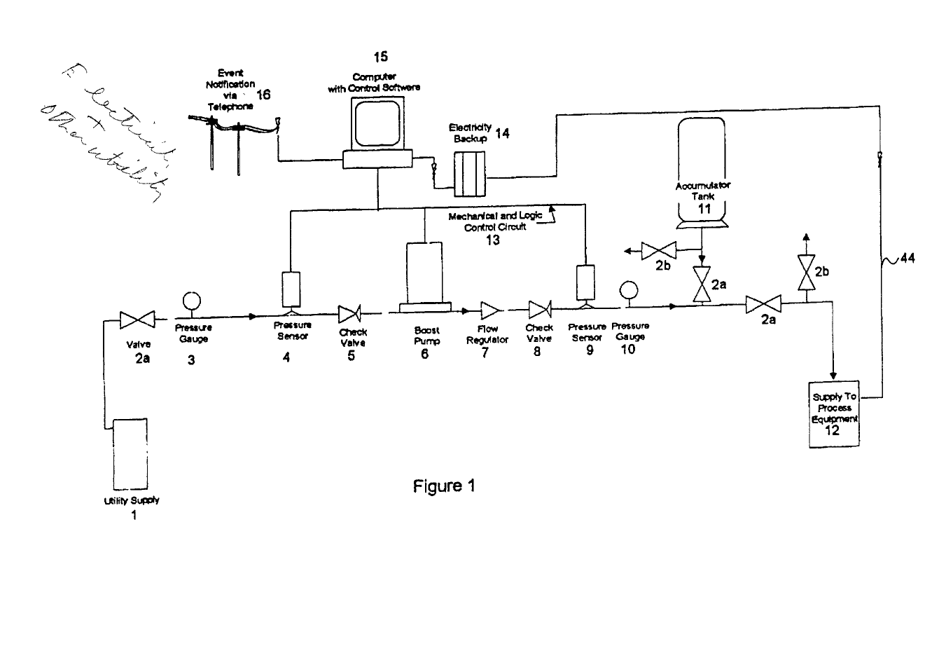

The regulation of standard electrical, pneumatic, and hydraulic utility services supplied to computer controlled equipment to within operator defined limits not exceeding maximum limits based on the specific design parameters of the IUBS system. The system regulation is accomplished using Pressure Sensor 4 and 9, Pressure Gauges 3 and 10, Boost Pump 6 and Flow Regulator 7 in FIG. 1. Flow direction is maintained using Check Valves 5 and 8.

Supply uninterruptible standard utility service to computer controlled equipment to allow for operation during intermittent periods when standard utilities are temporarily not supplied, or of such quality the equipment being supplied would be unable to function properly. The duration of such uninterruptible supplies would be limited to operator defined limits not exceeding maximum limits based on the specific design parameters of the IUBS. Storage of adequate utility supplies is accomplished through use of Electricity Backup 14, and Accumulator Tank 11.

Utilize a Computer with Control Software 15 in FIG. 1 to monitor, record, and maintain historic records of facility utility fluctuations, using operator definable limits not exceeding maximum limits based on the specific design parameters of the IUBS.

Utilize a Computer with Control Software 15 in FIG. 1 to provide for the safe, systematic shutdown of computer controlled equipment in the event acceptable standard utilities are unavailable for a duration exceeding operator defined limits not exceeding maximum limits based on the specific design parameters of the IUBS.

Remote monitoring of the utilities by a Computer with Control Software 15 in FIG. 1 capable of documenting the type and duration of the utility fluctuations, and providing a means of safe equipment shutdown if standard utility interruption is sustained beyond operator determined set points not exceeding maximum limits based on the specific design parameters of the IUBS.

Using Event Notification via Telephone 16 in FIG. 1, remote operator notification of system fluctuations and shutdowns are accomplished at an operator defined frequency and duration.

Preventative maintenance and repairs of equipment is facilitated by isolation valves, indicated on FIG. 1, used to allow isolated access to IUBS equipment.

The operation of the IUBS, and its relationship to the standard utility supplies can be described as follows:

Using FIG. 1, the Computer with Control Software 15 monitors the incoming supply to the Process Equipment 12 through Sensor 4 in the Utility Stream 2. The Accumulator Tank 11 provides a finite amount of reserved utility, in the event the Utility Supply 1 is not available. Sensor 4 evaluates whether the incoming Utility Stream 2 from the Utility Supply 1 is available, or not available. Sensor 9 monitors the Utility Supply 1 also, but initiates Boost Pump 6 in the event Utility Supply 1 is lower than the required minimum set point established in the Computer and Control Software. If the utility is not available, Sensor 4 sends a signal through the Mechanical a Logic Control Circuit 13 to Computer with Control Software 15 and signals Boost Pump 6 to discontinue operation. Computer with Control Software 15 generates an historical data point in memory, indicating the nature of the Utility Stream 2 deficiency, for future use by the Operator. The Supply to Process Equipment 12 will continue to be supplied with the conditioned utility at the predefined set points.

In the event the Utility Supply Stream 2 is discontinued, the Mechanical and Logic Control Circuit 13 will facilitate communication between Sensor 4 and 9, and shut down the Boost Pump 6. The Computer with Control Software 15 initiates a timed countdown that is defined by the Operator, to a maximum not to exceed the time necessary for the Process Equipment 12 to successfully complete its operation, whereby tee Process Equipment can be safely shutdown. The Accumulator Tank 11 will continue to supply the Process Equipment 12 with the necessary utility for the amount of time necessary to complete its operation.

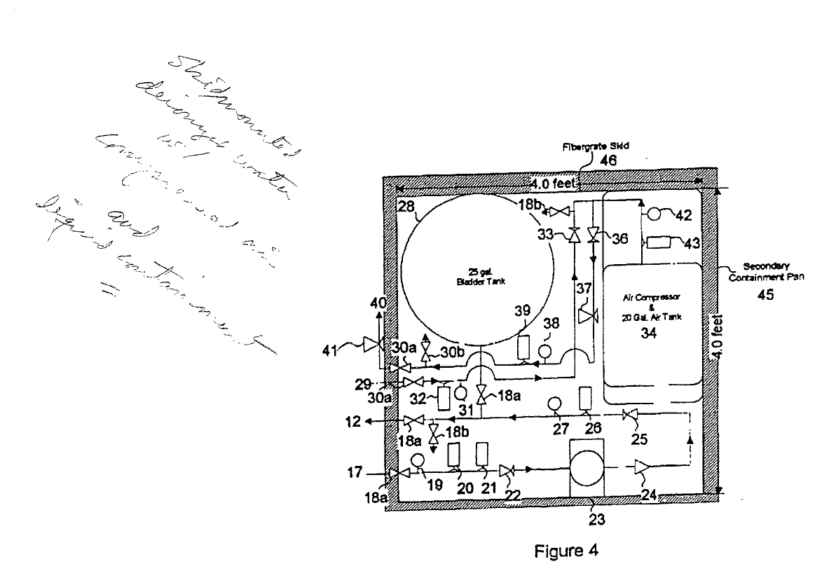

The IUBS System is fitted wit a Secondary Containment Device FIG. 4 item 45 designed to provide a controlled method of disposal of leakage, in the event the supplied utilities include liquids (e.g. Water).

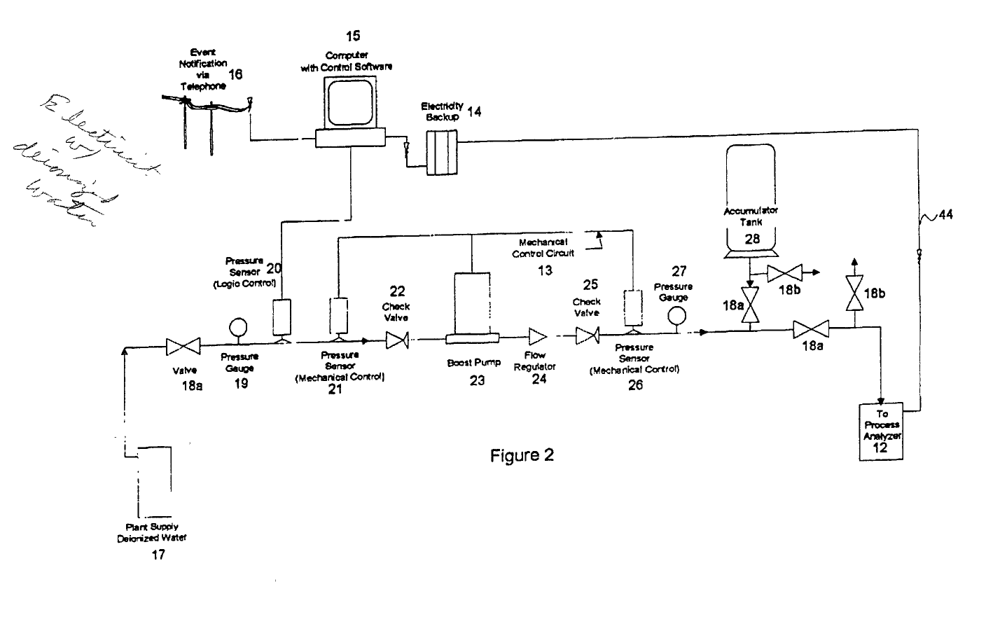

An example of how a IUBS System can be used is described below as follows: Referring to FIG. 2, Process Analyzer 12 requires a deionized water supply with a constant pressure. Utilizing an existing Plant Deionized Water Supply 17, deionized water is feed into the IUBS via Valve 18. Pressure Gauge 19 provides an instantaneous pressure reading of Plant Deionized Water Supply pressure. Pressure Sensor 20 monitors the incoming Plant Deionized Water Supply 17, and provides logic control to the Computer with Control Software. Pressure Sensor 21 is a normally open operational control for Boost Pump 23. Pressure from Plant Deionized Water Supply 17 forces the Pressure Sensor 21 to close, allowing the pump control circuit to operate. Deionized water flow direction is controlled by Check Valve 22 and 25, to insure that if the Plant Deionized Water Supply 17 pressure drops lower than the output pressure of Boost Pump 23, the higher pressure will be directed to Process Analyzer 12 only. So long as Pressure Sensor 21 is satisfied, should Plant Deionized Water Supply 17 line pressure fall below the set point of Pressure Sensor 26, Boost Pump 23 will come on, raising the line pressure going to the Process analyzer 12 and the pressure in the Accumulator Tank 28. The Process Analyzer 12 is rated to consume deionized water at a rate that is less than the Boost Pump 23 can provide. Flow Regulator 24 is used to control the speed at which the Accumulator Tank 28 is allowed to build pressure, eliminating Boost Pump 23 from overheating due to short cycling of the pump motor. The Accumulator Tank 28 is sized to provide an adequate amount of deionized water necessary to allow Process Analyzer 12 to complete one full analysis of the longest duration at a pressure consistent with the lowest pressure Accumulator Tank 28 experiences prior to Boost Pump 23 coming on. In the event the Plant Deionized Water Supply 17 completely shuts down, an adequate volume of deionized water at a pressure acceptable to the Process Analyzer 12 would be available to complete one entire analysis front the Accumulator Tank 28. Pressure Sensor 21 would detect the Plant Deionized Water Supply 17 is no longer available, would open the circuit controlling the operation of Boost Pump 23, preventing the pump from running dry. Pressure Sensor 20 will also detect the loss of Plant Deionized Water Supply 17, providing Computer with Control Software 15 with information that will systematically close the control software after a pried time frame. The time frame can be set at the Computer with Control Software 15 by the Operator to a time frame which is not less than the time required for the Process Analyzer 12 to complete its longest analysis. Adjustment to this time frame allows for short interruptions to Plant Deionized Water Supply 17 to occur without automatically shutting down the Process Analyzer 12. The Computer with Control Software 15 and the Process Analyzer 12 are equipped with auxiliary power backup in the event a power loss is experienced. In the event of power loss, the auxiliary power backup will maintain operation of the Process Analyzer 12 for a duration not less than the time required for the Process Analyzer 12 to complete an analysis of longest duration. The Computer with Control Software 15 will systematically close the control software after a predetermined time frame not less than the time required for the Process Analyzer 12 to complete its longest analysis. In the event the Computer with Control Software 15 has determined a shutdown is to occur, Event Notification via Telephone 16 is made. Event Notification via Telephone can be made in a form definable by the Operator. Preventative maintenance and equipment repair can be accomplished by utilizing any Isolation Valves (2a, 18a, 30a) and Drain Valves (2b, 18b, 30b).

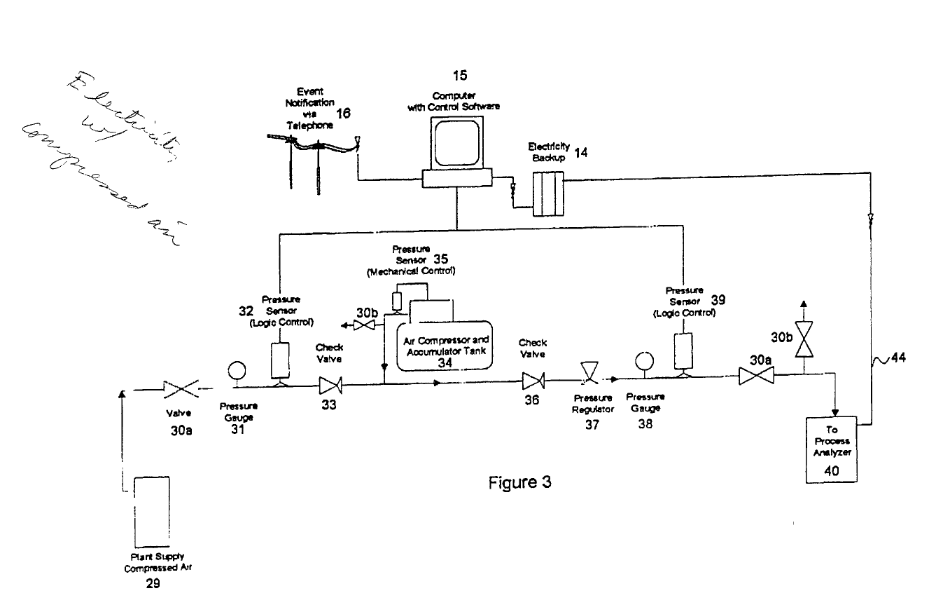

The FIG. 3 system demonstrates the structure of a Compressed Air Supply System, it operates in a similar fashion as FIG. 2, the deionized water supply system, the difference in these two system structures would be FIG. 3 , Plant Supply Compressed Air 29, can utilize surrounding air to supply the compressor pump. In FIG. 2, Plant Supply Deionized Water 17 is required to be operational for the Boost Pump 23 to increase deionized water pressure required by the Process Analyzer 12.

The FIG. 4 is a skid mount 46 installation plan view of a deionized water and compressed air backup system with secondary containment 45. The footprint included provides an example of the amount of floor space required for a typical system. Dimensional information will vary based on utility demands.

We claim:

1. A utility backup system comprising a plurality of separate means to accumulate and retain a predetermined quantity of each utility, a plurality of corresponding separate means to supply as needed each utility to process equipment from each predetermined utility quantity in response to a supply failure of at least one utility, and control means to actuate the response to the supply failure for a predetermined time period.

2. A method of protecting a process against failure caused by utility supply failure comprising the steps of: accumulating a predetermined quantity of each utility, retaining the predetermined quantity of each utility in readiness during normal utility supply to the process, automatically supplying one or more utilities to the process in response to a failure of normal utility supply and communicating the existence of the failure to a decision maker for continued process operation or controlled process shut down.
